(19) United States
(12) Patent Application Publication
(10) Pub. No.: US 2026/0334428 A1
(43) Pub. Date: Oct. 29, 2026

(54) MODULAR PET CAGE

(71) Applicant: FLEXISPOT INC., Irvine, CA (US)

(72) Inventors: Lehong XIANG, Irvine, CA (US); Haoyu YE, Irvine, CA (US); Mengting LIN, Irvine, CA (US); Keyao LIU, Irvine, CA (US); Shuang ZHAO, Irvine, CA (US); Minquan TAO, Irvine, CA (US)

(21) Appl. No.: 19/193,145

(22) Filed: Apr. 29, 2025

(51) Int. Cl. A01K 1/03

(52) U.S. Cl. CPC A01K 1/033

(57) ABSTRACT

The present disclosure discloses a modular pet cage, including a cage body and at least one module component. The cage body internally has an activity space for a pet to move in. The cage body includes a plurality of panel components, and the plurality of panel components are arranged in an enclosing manner and spliced to define a volume of the cage body. The module component has an internal space, and is connected to the cage body after any one of the panel components is disconnected, to increase the activity space of the cage body. The modular pet cage has high flexibility in volume expansion, a large degree of freedom and a simple structure, and achieves ease and fastness of assembly.

### TECHNICAL FIELD

The present disclosure relates to the technical field of pet products, and specifically, to a modular pet cage.

### BACKGROUND

A pet cage is a necessary pet product for dogs, cats, guinea pigs, rabbits, and other pets to provide a safe, secure, and comfortable living environment. To facilitate packaging and transportation, most pet cages in related technologies are designed to be assemblable or foldable. After the pet cage is assembled or unfolded, a space defined inside the pet cage is fixed. However, as pets grow in body size and increase in number and there is a requirement for an expanded pet activity range, a user often has to replace the pet cage with a larger one, resulting in a waste of resources and increasing a purchase burden over the user.

Therefore, it is necessary to expand the space of the pet cage. That is, the internal space of the pet cage is adjusted based on the body size, the number, the activity range requirement, and the like of the pets. For example, a Chinese Patent Application No. CN112753594A entitled “MODULAR FRAME EXPANDABLE TO FORM PET CAGE” is provided, including a plurality of modules. Each of the modules includes substantially quadrilateral vertical walls, and adjacent vertical walls are engaged by connecting elements to form a pet cage. A number of spliced modules determines a size of the internal space of the pet cage, such that the space of the pet cage can be expanded as required. For another example, a Chinese Patent Application No. CN218184599U entitled “PET CAGE WITH EXPANDABLE SPACE” is provided. The pet cage is provided with a first support frame, a first hollow rod, a second support frame, a first solid rod, a second hollow rod, a second solid rod, and the like that cooperate with each other to extend or retract, such that an entire space can be expanded. When a pet grows in body size, the pet cage can be expanded in a timely manner, such that the pet can have a sufficient space for stretching. For another example, a patent No. CN221059182U entitled “SPATIALLY EXPANDABLE PET CAGE” is provided. A pet cage is connected to another pet cage by an adjusting plate, and the adjusting plate can slide in one of the pet cages to adjust a pet activity space in the pet cage.

In addition, most of the pet cages in the above-mentioned related technologies are fitted with furniture to save an indoor space. For example, the pet cage is placed in a compartment of the furniture or the pet cage is placed under a table, and the pet cage with an expandable space can increase the volume according to a size of a furniture space to be fitted with the furniture space, and the activity space in the pet cage can be expanded.

The pet cage with an expandable space in the above-mentioned related technology has the following defects in actual production or use. When the pet cage expands the volume to be fitted with a reserved space of the furniture, an expansion direction of the volume of the pet cage is generally fixed and single. As a result, flexibility is poor, and the pet cage cannot be fitted with the space of the furniture well. In addition, for a pet cage with a large number of vertical wall modules spliced to expand the space, each vertical wall needs to be connected by a connecting element or assembled independently. As a result, a user needs to spend more time during assembly, assembly efficiency is low, and assembly difficulty is high. For a pet cage that uses a telescopic structure to expand a space, there are more parts used and a relatively complicated structure, assembly of the telescopic structure is troublesome, and there is a limited expanded space and a smaller degree of freedom of space expansion, which cannot meet requirements of the user.

### SUMMARY

Against the technical problems to be solved by the present disclosure, to overcome the shortcomings of the above-mentioned related technologies, a modular pet cage that has high flexibility in volume and pet activity space expansion, a large degree of freedom and a simple structure, and achieves ease and fastness of assembly is provided.

A technical solution of the present disclosure is to provide a modular pet cage with the following structure, including:
a cage body internally having an activity space for a pet to move in, where the cage body includes a plurality of panel components, and the plurality of panel components are arranged in an enclosing manner and spliced to define a volume of the cage body; and
at least one module component having an internal space and connected to the cage body after any one of the panel components is disconnected, to increase the activity space of the cage body.

In some embodiments, the module component is a frame body, and the frame body is connected to the cage body to form an enclosure after the panel component is disconnected, such that an internal space of the frame body communicates with an internal space of the cage body.

In some embodiments, the frame body is formed by sequentially splicing a plurality of plates end to end, the frame body is open and has a first end face and a second end face that are located at two ends inside, the first end face of the frame body is connected to the cage body after the panel component is disconnected, and the disconnected panel component is connected to the second end face of the frame body.

In some embodiments, a cross section of the frame body is one of a polygon, a circle, or an ellipse.

In some embodiments, at least one panel component is configured as a door panel capable of opening or closing the cage body.

In some embodiments, the frame body includes a first plate, a second plate, a third plate and a fourth plate, and the first plate, the second plate, the third plate and the fourth plate are sequentially detachably connected to form the frame body of a quadrilateral shape.

In some embodiments, the plurality of panel components sequentially include a top panel component, a bottom panel component, a front panel component, a rear panel component, a left panel component and a right panel component, and the top panel component, the bottom panel component, the front panel component, the rear panel component, the left panel component and the right panel component are sequentially arranged in an enclosing manner to form the cage body of a square shape.

In some embodiments, after at least one of the left panel component and the right panel component is disconnected, the frame body is connected to the cage body to increase a volume of the pet cage in a length direction; and/or
after at least one of the top panel component and the bottom panel component is disconnected, the frame body is connected to the cage body to increase the volume of the pet cage in a height direction; and/or
after at least one of the front panel component and the rear panel component is disconnected, the frame body is connected to the cage body to increase the volume of the pet cage in a width direction.

In some embodiments, after the left panel component is disconnected, the first end face of the frame body is connected to a left side of the cage body, and the left panel component is connected to the second end face of the frame body; and/or
after the right panel component is disconnected, the first end face of the frame body is connected to a right side of the cage body, and the right panel component is connected to the second end face of the frame body.

In some embodiments, a plurality of frame bodies are provided, and the plurality of frame bodies include a first frame body, a second frame body, and a third frame body;
after the right panel component is disconnected, a first end face of the first frame body is connected to a right side of the cage body, and the right panel component is connected to a second end face of the first frame body;
after the left panel component is disconnected, a first end face of the second frame body is connected to a left side of the cage body, and the left panel component is connected to a second end face of the second frame body;
after the rear panel component is disconnected, a first end face of the third frame body is connected to a rear side of the cage body, and the rear panel component is connected to a second end face of the third frame body; and
the first end face of the third frame body is connected to end faces of a first plate and a second plate of the first frame body, and a fourth plate of the first frame body is connected to the second end face of the third frame body; the first end face of the third frame body is connected to end faces of a first plate and a second plate of the second frame body, and a fourth plate of the second frame body is connected to the second end face of the third frame body.

In some embodiments, a plurality of frame bodies are provided, and after the panel component is disconnected, the plurality of frame bodies are sequentially stacked and connected in a width direction, a frame body close to the cage body is connected to the cage body, and the disconnected panel component is connected to a frame body away from the cage body.

In some embodiments, at least one panel component includes a frame and a mesh plate connected in the frame.

In some embodiments, adjacent panel components are detachably connected by an engaging element.

In some embodiments, at least one panel component is configured as a functional panel, and the functional panel is configured to mount a functional accessory.

To sum up, compared with the related technologies, the modular pet cage according to the present disclosure has the following advantages. The modular pet cage includes the cage body and the at least one module component, where the cage body is formed by the plurality of panel components through enclosing and splicing. The module component is an independent functional component and has the internal space. The module component is connected to the cage body after any one of the panel components is disconnected, to increase the volume of the pet cage and expand the pet activity space in the cage body. Therefore, when the pet cage is fitted with a furniture space, the volume of the pet cage can be expanded by mounting module components on the cage body, an appropriate number of module components may be selected according to a size of the furniture space to be connected to the cage body, and the module components may be connected according to a volume expansion direction of the cage body. Therefore, the modular pet cage has high flexibility in volume expansion, a large degree of freedom and a simple structure, and achieves ease and fastness of assembly. In addition, the mounting of the module components can expand the pet activity space in the cage body, and meet requirements for a larger activity range due to growth in body size and increase in number of the pets, and the like.

Another technical solution of the present disclosure is to provide a modular pet cage with the following structure, including:
a cage body internally having an activity space for a pet to move in, where the cage body includes a plurality of panel components, and the plurality of panel components are arranged in an enclosing manner and spliced to define a volume of the cage body; and
at least one functional module connected to the cage body and configured to increase the volume of the cage body.

In some embodiments, the modular pet cage further includes at least one module component, which has an internal space, and is connected to the cage body after any one of the panel components is disconnected, to increase the activity space of the cage body.

In some embodiments, the functional module is connected to the cage body to form an enclosure after any one of the panel components is disconnected.

In some embodiments, the functional module is configured as one or more of a feeding module, a temperature control module, a disinfection module, a cleaning module, a monitoring module, a storage module, and a decoration module.

In some embodiments, the module component is a frame body, and the frame body is connected to the cage body to form an enclosure after the panel component is disconnected, such that an internal space of the frame body communicates with an internal space of the cage body.

In some embodiments, the frame body is formed by sequentially splicing a plurality of plates end to end, the frame body is open and has a first end face and a second end face that are located at two ends inside, the first end face of the frame body is connected to the cage body after the panel component is disconnected, and the disconnected panel component is connected to the second end face of the frame body.

To sum up, compared with the related technologies, the modular pet cage according to the present disclosure has the following advantages. The modular pet cage includes the cage body and the at least one functional module, where the cage body is formed by the plurality of panel components through enclosing and splicing. The functional module is an independent functional component, such as a feeding module, a temperature control module, a disinfection module, a cleaning module, a monitoring module, a storage module, and a decoration module. The functional component has a certain volume, and can increase the volume of the pet cage after being mounted on the cage body. Therefore, when the pet cage is fitted with a furniture space, the volume of the pet cage can be expanded by mounting the functional modules on the cage body, an appropriate number of functional modules may be selected according to a size of the furniture space to be connected to the cage body, and the functional modules may be connected according to a volume expansion direction of the cage body. Therefore, the modular pet cage has high flexibility in volume expansion, a large degree of freedom and a simple structure, and achieves ease and fastness of assembly.

### BRIEF DESCRIPTION OF THE DRAWINGS

FIG. 1 is a schematic structural diagram of a cage body of a modular pet cage according to the present disclosure;

FIG. 2 is a schematic structural diagram of a cage body of a modular pet cage according to the present disclosure from another angle;

FIG. 3 is a schematic structural diagram of a frame body of a modular pet cage according to the present disclosure;

FIG. 4 is a schematic structural diagram of a right panel component of a modular pet cage according to the present disclosure;

FIG. 5 is a schematic structural diagram of connection between a cage body and a frame body of a modular pet cage according to the present disclosure;

FIG. 6 is a schematic structural diagram of connection between a cage body and a frame body of a modular pet cage according to the present disclosure from another angle;

FIG. 7 is a schematic structural diagram of connection between a frame body and a right panel component of a modular pet cage according to the present disclosure;

FIG. 8 is a schematic structural diagram of a modular pet cage according to some implementations of the present disclosure;

FIG. 9 is a schematic structural diagram of a modular pet cage according to some implementations of the present disclosure from another angle;

FIG. 10 is a schematic diagram of a frame body connecting structure of a modular pet cage according to some implementations of the present disclosure;

FIG. 11 is a schematic diagram of a frame body connecting structure of a modular pet cage according to some implementations of the present disclosure from another angle;

FIG. 12 is a schematic structural diagram of a modular pet cage according to some other implementations of the present disclosure;

FIG. 13 is a schematic structural diagram of a modular pet cage according to some other implementations of the present disclosure from another angle;

FIG. 14 is a schematic diagram of a frame body connecting structure of a modular pet cage according to some other implementations of the present disclosure; and

FIG. 15 is a schematic diagram of a frame body connecting structure of a modular pet cage according to some other implementations of the present disclosure from another angle.

### DESCRIPTION OF REFERENCE NUMERALS

1. cage body, 100. top panel component, 101. bottom panel component, 102. front panel component, 103. rear panel component, 104. left panel component, 105. right panel component, 106. frame, 107. mesh plate, 2. frame body, 200. first plate, 201. second plate, 202. third plate, 203. fourth plate, 3. storage module, 4. first frame body, 400. first plate a, 401. second plate a, 402. third plate a, 403. fourth plate a, 5. second frame body, 500. first plate b, 501. second plate b, 502. third plate b, 503. fourth plate b, 6. third frame body, 600. first plate c, 601. second plate c, 602. third plate c, 603. fourth plate c.

### DETAILED DESCRIPTION

First, a person skilled in the art should understand that these implementations are only used to explain the technical principles of embodiments of the present disclosure, and are not intended to limit the protection scope of the present disclosure. A person skilled in the art can make adjustments to the implementations as required, so as to adapt to specific application scenarios.

In the description of the embodiments of the present disclosure, it should be noted that, unless otherwise clearly specified and limited, term “connected” or “connection” should be understood in a broad sense. For example, the term may be a fixed connection, a removable connection, or an integral connection; may be a mechanical connection or an electrical connection; and may be a direct connection or an indirect connection by an intermediate medium. A person of ordinary skill in the art may understand specific meanings of the above terms in the embodiments of the present disclosure based on a specific situation.

In the embodiments of the present disclosure, unless otherwise explicitly specified and defined, that a first feature is “above” or “below” a second feature may be that the first feature is in direct contact with the second feature, or the first feature is in indirect contact with the second feature by an intermediate medium. In addition, that the first feature is “above” the second feature may indicate that the first feature is over or obliquely above the second feature, or may merely indicate that a level height of the first feature is higher than that of the second feature. That the first feature is “below” the second feature may be that the first feature is under or obliquely below the second feature, or may merely indicate that a level height of the first feature is lower than that of the second feature.

The present disclosure is further described in detail below with reference to the accompanying drawings and specific embodiments.

### Embodiment 1

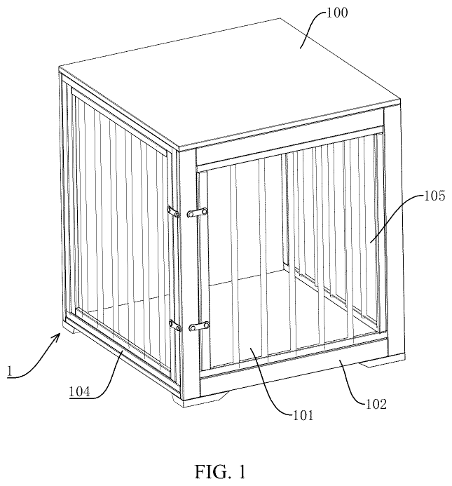

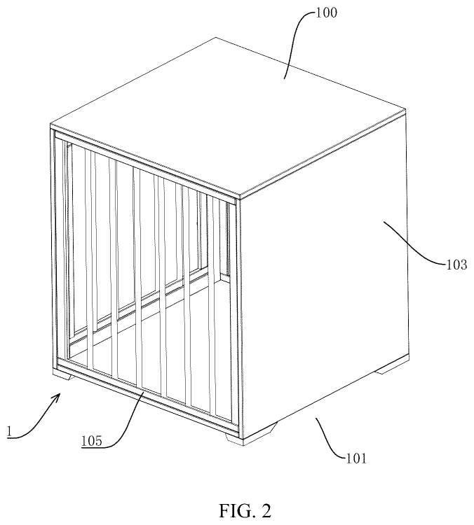

As shown in FIG. 1 and FIG. 2, this embodiment of the present disclosure discloses a modular pet cage, which is suitable for cats, dogs, guinea pigs, rabbits, and other pets, and belongs to pet products. In this embodiment, the pet cage includes a plurality of panel components. The plurality of panel components are arranged in an enclosing manner and spliced to form a cage body 1, and the cage body 1 internally has an activity space for a pet to move in. Specifically, in this embodiment, the cage body 1 is of a cuboid or cubic structure, and the plurality of panel components sequentially include a top panel component 100, a bottom panel component 101 opposite to the top panel component 100, a front panel component 102, a rear panel component 103 opposite to the front panel component 102, a left panel component 104, and a right panel component 105 opposite to the left panel component 104. The top panel component 100, the bottom panel component 101, the front panel component 102, the rear panel component 103, the left panel component 104, and the right panel component 105 are sequentially arranged in an enclosing manner to form the cage body 1 of a square shape.

It can be understood that, to facilitate production, packaging, and transportation of the pet cage, the plurality of panel components of the pet cage are configured as mutually spliced structures, which are sequentially disassembled and stacked during packaging or transportation, and are assembled together by engaging elements such as fasteners, connecting members, or adhesives after being purchased by a user to form a pet cage for a pet to live in. It can be understood that each panel component can be disassembled to be disconnected from the cage body.

For example, a left side and a right side of the top panel component 100 are respectively connected to upper ends of the left panel component 104 and the right panel component 105 by fasteners, and a lower end of the left panel component 104 and a lower end of the right panel component 105 are respectively connected to two ends of the bottom panel component 101 by fasteners. Then, the rear panel component 103 is sequentially connected to a rear end of the top panel component 100, a rear end of the bottom panel component 101, a rear end of the left panel component 104, and a rear end of the right panel component 105 by fasteners, and then the front panel component 102 is sequentially connected to a front end of the top panel component 100, a front end of the bottom panel component 101, a front end of the left panel component 104, and a front end of the right panel component 105 by fasteners.

In this embodiment, the term such as “top”, “bottom”, “front”, “rear”, “left”, or “right” indicating an orientation is based on an orientation determined by left and right hands when the user faces the drawing in the specification, or an orientation of the pet cage in a general usage state.

In this embodiment, at least one panel component is configured as a door panel capable of opening or closing the cage body 1, and the door panel may be arranged on the front panel component 102, the rear panel component 103, the top panel component 100, the left panel component 104, or the right panel component 105. This may be specifically set according to personal interests and hobbies or user customization.

For example, as shown in FIG. 1, the door panel is arranged on the front panel component 102, and the front panel component 102 includes a frame 106 and a mesh plate 107 connected in the frame 106. The mesh plate 107 includes a plurality of metal rods that are sequentially distributed at intervals, and a gap between adjacent metal rods should prevent a pet from passing therethrough. In this embodiment, the mesh plate 107 may be configured to have one end rotatably hinged, such that the mesh plate 107 is rotatably opened; or the mesh plate 107 is configured to be slidably connected, such that the cage body 1 is opened after the mesh plate 107 slides outward for a certain displacement.

In another embodiment, the mesh plate may alternatively be a mesh-hole plate or a grid-shaped mesh plate woven with a metal wire.

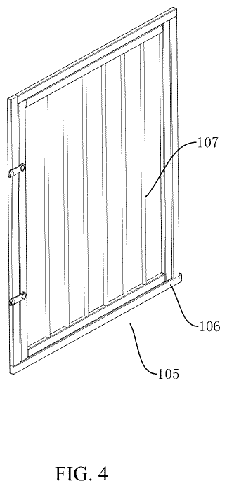

As shown in FIG. 4, the right panel component 105 is configured as a mesh plate 107 structure, that is, the right panel component has a frame 106 and a mesh plate 107 mounted in the frame 106. Specifically, in this embodiment, as shown in FIG. 1 and FIG. 2, the front panel component 102, the left panel component 104, and the right panel component 105 each are of a mesh plate structure, while the top panel component 100, the rear panel component 103, and the bottom panel component 101 each are an integrated plate or an assembled and spliced planar flat plate.

In some embodiments, the plurality of panel components constituting the cage body may be configured as the same panel components, such as mesh plate-shaped mesh plate structures, or at least a part of the panel components may be configured as a mesh plate structure.

In the above embodiment, it can be understood that, after any panel component is disconnected, an open portion or an opening communicating with an internal space of the cage body 1 is formed in the cage body 1. For example, after the right panel component 105 is disassembled, an opening is formed in a right side of the cage body 1, or the right side of the cage body 1 is opened.

To make the pet cage better fitted with a space of furniture and increase the activity space of the cage body 1, the modular pet cage further includes at least one module component. The module component is an independent functional component arranged on an outer side of the cage body, and the module component is internally hollow. The module component can increase the volume of the pet cage after being connected to the cage body. Therefore, when the pet cage is fitted with a furniture space, the volume of the pet cage can be expanded by mounting the module components on the cage body, an appropriate number of the module components may be selected according to a size of the furniture space to be connected to the cage body 1, and the module components may be connected according to a volume expansion direction of the cage body 1. Therefore, the modular pet cage has high flexibility in volume expansion, a large degree of freedom and a simple structure, and achieves ease and fastness of assembly. In addition, the module component is a hollow component, and after the module component is connected to the cage body 1, an internal space of the module component can expand the activity space in the cage body 1, such that the activity space of the pet cage for a pet to move is expanded, thereby meeting requirements for a larger activity range due to growth in body size and increase in number of the pets, and the like.

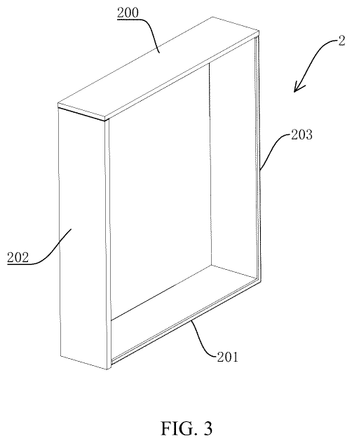

As shown in FIG. 3, the module component is a frame body 2 having an internal space, and the frame body 2 is connected to the cage body 1 to form an enclosure after the panel component is disconnected, such that an internal space of the frame body 2 communicates with an internal space of the cage body 1 to expand the pet activity space. It can be understood that after the panel component of the cage body 1 is disconnected, the frame body 2 is connected at the opening or an open part of the cage body 1, such that the frame body 2 and the cage body 1 form a pet cage together. The frame body 2 may be configured as being closed around with one end open and the other end closed, such that an internal space is formed in the frame body 2 in a width direction of the frame body, and a volume of the internal space is also the volume in the frame body. After being connected to the cage body 1 to form an enclosure, the frame body 2 forms a complete pet cage with the cage body 1.

Specifically, in this embodiment, the frame body 2 may be configured as a frame body closed around with two ends open. That is, the frame body 2 is formed by sequentially splicing a plurality of plates end to end, and the frame body 2 is open and has a first end face and a second end face that are located at two ends inside. That is, both the first end face and the second end face of the frame body 2 have openings communicating with the internal space of the frame body. The first end face of the frame body 2 is connected to the cage body 1 after the panel component is disconnected, and the disconnected panel component is connected to the second end face of the frame body 2.

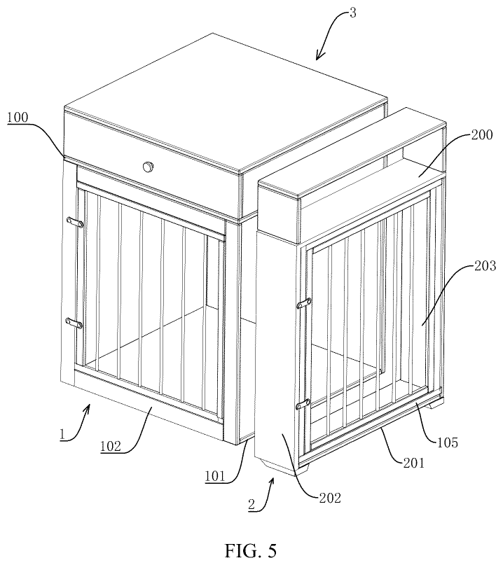

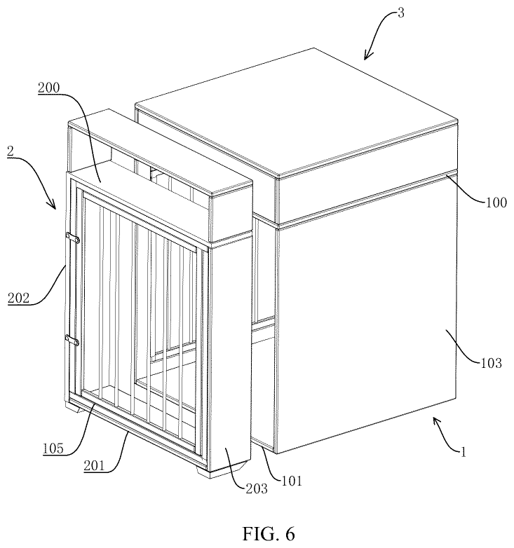

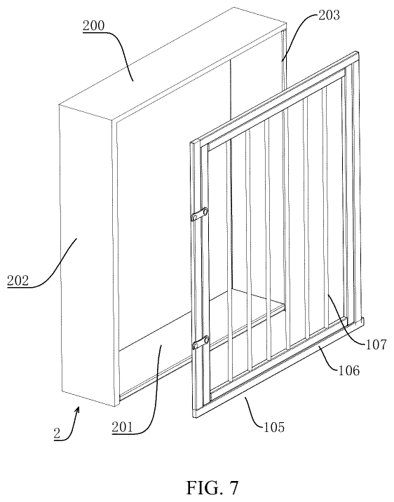

For example, as shown in FIG. 3, the frame body 2 is formed by sequentially splicing four plates end to end, and the frame body 2 has a first end face and a second end face that are open and communicate with the internal space. Specifically, the shape of the frame body 2 is fitted with the shape of the panel component, and is configured as a quadrilateral. The frame body 2 structurally includes a first plate 200 and a second plate 201 that are arranged horizontally and a third plate 202 and a fourth plate 203 that are arranged vertically. The first plate 200, the second plate 201, the third plate 202, and the fourth plate 203 are connected end to end and arranged in an enclosing manner to form a quadrilateral frame body. Widths of the first plate 200, the second plate 201, the third plate 202, and the fourth plate 203 are the same. When the volume of the pet cage is increased and the pet activity space in the cage body 1 is expanded, further referring to FIG. 5, FIG. 6, and FIG. 7, the right panel component 105 on the right side of the cage body 1 is disassembled. Therefore, the right side of the cage body 1 is open or is formed with an opening, such that the first end face of the frame body 2 is engaged at the opening of the cage body 1 by a connecting member, and then the disassembled right panel component 105 is mounted at the second end face of the frame body 2. Therefore, the internal space of the cage body 1 communicates with the internal space of the frame body 2, thereby expanding the activity space of the cage body 1.

In some embodiments, to make a package small in volume and facilitate transportation, the first plate 200, the second plate 201, the third plate 202, and the fourth plate 203 of the frame body 2 are spliced by detachable connecting structures, and for example, are connected by connecting members such as screws and connecting pieces.

In the modular pet cage of this embodiment, when the activity space in the cage body 1 is expanded, only any one or more panel components need to be disassembled, a corresponding number of frame bodies for expansion are selected and connected to the cage body 1, and then the disassembled panel components are sequentially connected to the second end face of the frame body 2. In this way, the activity space in the frame body 2 communicates with the internal space in the cage body 1, such that the space of the pet cage for a pet to move in is expanded, thereby meeting requirements for a larger activity range due to growth in body size and increase in number of the pets, and the like. In the modular pet cage, the internal space of the pet cage is expanded by disassembling the panel components and correspondingly assembling a different number of frame bodies 2, and therefore, the modular pet cage has a simple structure, achieves ease and fastness of assembly, and has a large degree of freedom of space expansion.

It is not difficult to understand that after any panel component of the cage body 1 is disconnected, frame bodies 2 can be mounted to expand the space. The user can expand the space by mounting the frame bodies 2 above, below, on the left side, on the right side, on the front side, or on the rear side of the cage body 1, that is, the cage body 1 can be expanded in a length direction, a width direction, and a height direction, such that the modular pet cage has a larger degree of freedom in space expansion when the internal space of the cage body 1 is expanded.

It can be understood that when the user uses the pet cage, to avoid occupying an indoor space, the pet cage is often placed at a bottom of existing furniture or in a special storage cavity, such as in a space under a table board of a lifting table or a compartment of a cabinet. However, the modular pet cage of this embodiment has a larger degree of freedom in space expansion. Especially when the modular pet cage is fitted with the existing furniture for use, the volume of the pet cage is expanded by mounting the frame bodies 2, such that external dimensions of the pet cage are fitted with a placement space of the furniture, thereby fully utilizing the placement space of the existing furniture.

In the above embodiment, the cage body 1 is of a cuboid or cubic structure, and therefore, the frame body 2 is shaped to be a square or quadrilateral that is fitted with the panel component.

In another embodiment, the cage body may alternatively be configured in another shape, for example, a regular shape such as a sphere, a cylinder or a polyhedron, or a special-shaped and irregular shape, as long as it can be ensured that the cage body can be engaged to the frame body, to be fitted with a reserved placement space of the furniture and meet requirements for fitting consistency between the pet cage and the furniture and aesthetics. That is, after the frame body is engaged to the cage body, external shapes of the frame body and the cage body should be as fitted as possible with the shape of the reserved placement space of the furniture, and the internal spaces of both should communicate. Alternatively, the user may choose different models or dimensions of cage bodies and frame bodies for custom assembly based on the size of the reserved space of the furniture. A single or a plurality of frame bodies may alternatively be spliced to form various irregular shapes such as an arc, a broken line, or an L shape.

For example, the cage body is cylindrical as a whole, and panel components at both ends of the cage body are circular panels. The frame body fitted with the cage body is also shaped to be cylindrical. After one of the panel components of the cage body is disassembled, the frame body may be engaged to the cage body. Therefore, the pet cage composed of the cage body and the frame body is also cylindrical as a whole. Alternatively, the cage body is cylindrical, a cross section of the frame body is circular, and the frame body is in the shape of an arc, an L, or the like in a length direction. After the frame body is connected to the cage body, the entire pet cage is irregularly arranged.

Further, for example, the pet cage includes an irregular cage body and an L-shaped frame body assembly formed by splicing a plurality of frame bodies, and internal spaces of the plurality of frame bodies of the frame body assembly communicate with each other. One end of the frame body assembly is engaged to the cage body, and the frame body assembly communicates with the internal space of the cage body, such that the assembled pet cage is in a special shape as a whole.

In this embodiment, the disassembled panel component is generally mounted in the frame body 2, and an outer side wall of the panel component is flush with an end face of a second end of the frame body 2 and connected to the end face by a connecting member. In another embodiment, the disassembled panel component may alternatively be directly engaged to the end face of the second end of the frame body 2, that is, the panel component protrudes from the end face of the second end of the frame body 2.

In this embodiment, as shown in FIG. 1, FIG. 2, and FIG. 3, a stacking direction of the frame bodies 2 on the cage body 1 or a volume expansion direction of the cage body may be the height direction, the length direction, or the width direction of the cage body 1. After at least one of the left panel component 104 and the right panel component 105 is disconnected, the frame bodies 2 are connected to the cage body 1 to increase the volume of the pet cage in the length direction. After at least one of the top panel component 100 and the bottom panel component 101 is disconnected, the frame bodies 2 are connected to the cage body 1 to increase the volume of the pet cage in the height direction. After at least one of the front panel component 102 and the rear panel component 103 is disconnected, the frame bodies 2 are connected to the cage body 1 to increase the volume of the pet cage in the width direction. That is, the frame bodies 2 may be connected to the top, the bottom, the left side, the right side, the front side, the rear side, or the like of the cage body 1, such that the volume and the pet activity space of the cage body can be expanded in the length direction, the width direction, and the height direction.

For example, as shown in FIG. 5 and FIG. 6, the frame body 2 may be connected to the right side or the left side of the cage body 1. In an example in which the frame body is connected to the right side of the cage body 1, after the right panel component 105 is disconnected, the first end face of the frame body 2 is engaged to the right side of the cage body 1, and the right panel component 105 is connected to the second end face of the frame body 2. Alternatively, after the left panel component 104 is disconnected, the first end face of the frame body 2 is connected to the left side of the cage body 1, and the left panel component 104 is connected to the second end face of the frame body 2. In this way, the volume can be selectively expanded on one side of the cage body 1, such that the volume and space expansion of the cage body 1 is freer and more convenient.

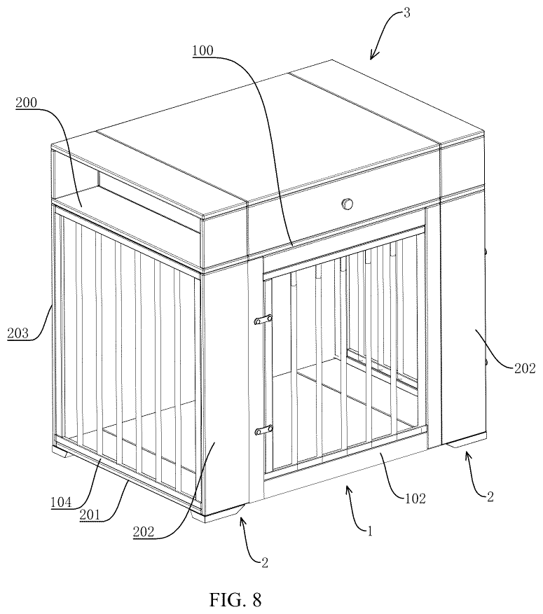

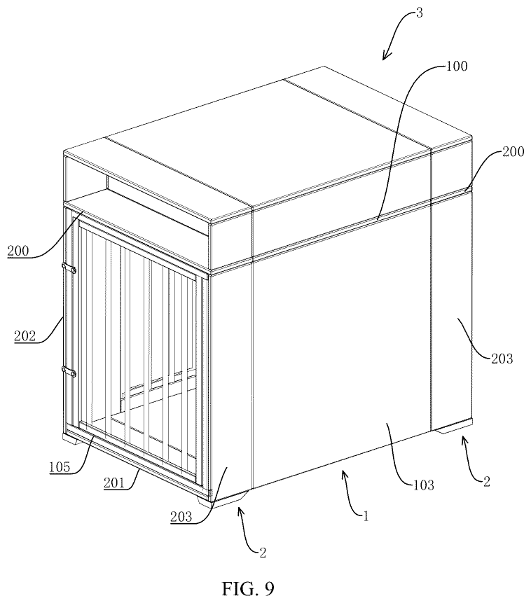

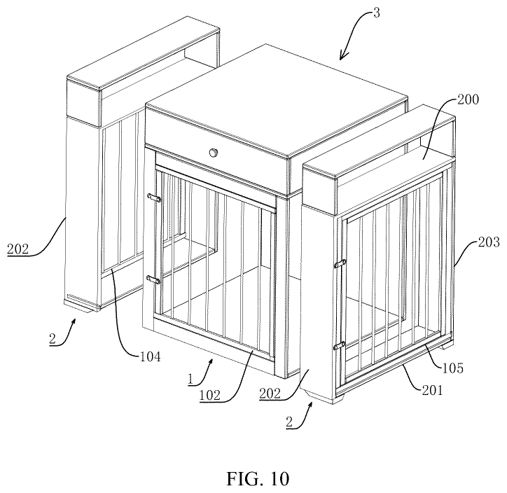

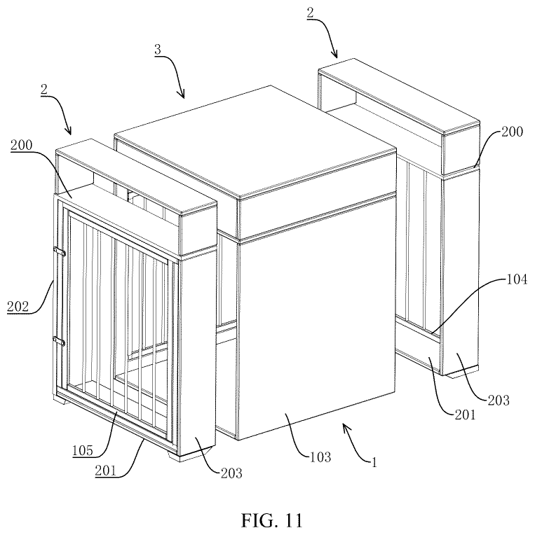

In some embodiments, as shown in FIG. 8, FIG. 9, FIG. 10, and FIG. 11, there are two frame bodies 2, and the two frame bodies 2 are respectively arranged on the left side and the right side of the cage body 1. Specifically, the right panel component 105 and the left panel component 104 are separately disconnected, and then the two frame bodies 2 are respectively engaged to the left side and the right side of the cage body 1. Then,-the disassembled right panel component 105 is connected to the second end face of the right frame body 2, and the left panel component 104 is connected to the second end face of the left frame body 2, such that the space can be expanded on both sides of the cage body 1, thereby further improving freedom of space expansion of the pet cage.

In some embodiments, based on that frame bodies 2 are mounted to the left side and/or the right side of the cage body 1 to expand the space, a frame body 2 is mounted to the rear side of the cage body 1 to expand the space at the rear side of the pet cage. Specifically, after the rear panel component 103 is disconnected, the first end face of the frame body 2 is connected to the rear side of the cage body 1, and the rear panel component 103 is connected to the second end face of the frame body 2; the first end face of the frame body located on the rear side of the cage body 1 is engaged to end portions of the first plate 200 and the second plate 201 of the frame body located on the right side of the cage body 1, and the fourth plate 203 of the frame body located on the right side of the cage body 1 is connected to the second end face of the frame body located on the rear side of the cage body 1; and/or the first end face of the frame body located on the rear side of the cage body 1 is engaged to end portions of the first plate 200 and the second plate 201 of the frame body located on the left side of the cage body 1, and the fourth plate 203 of the frame body located on the left side of the cage body 1 is connected to the second end face of the frame body located on the rear side of the cage body 1.

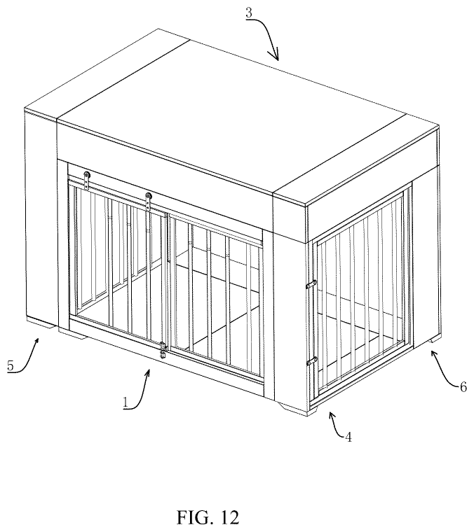

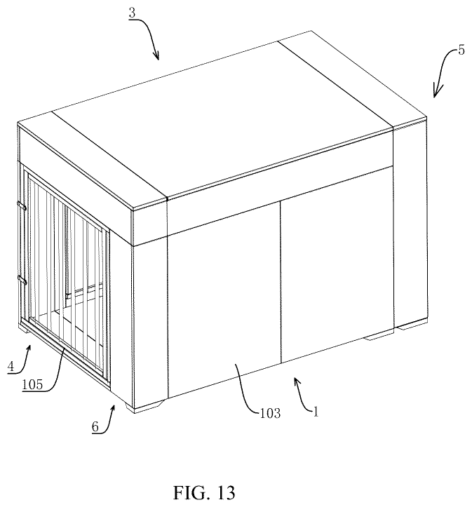

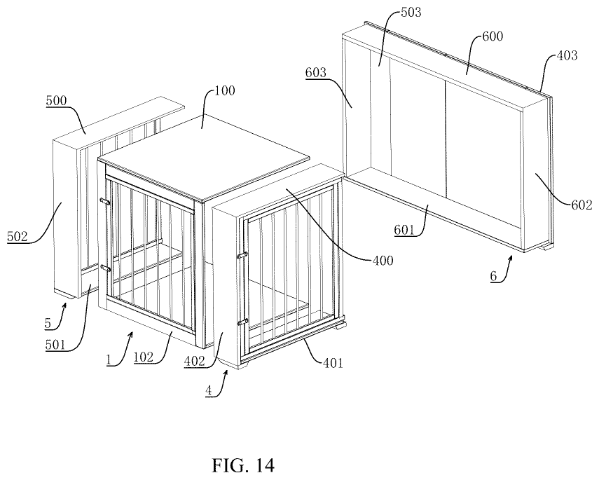

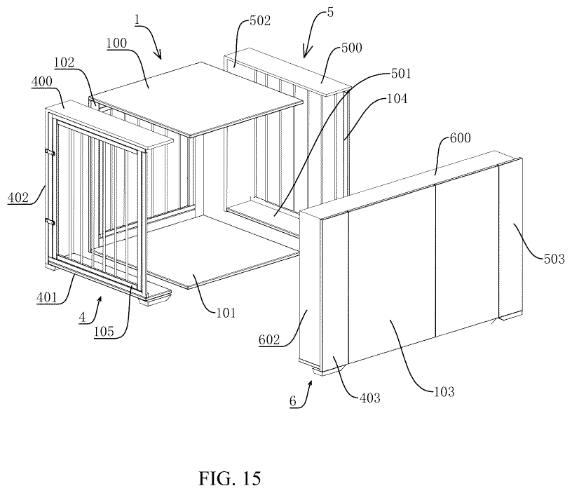

For example, as shown in FIG. 12, FIG. 13, FIG. 14, and FIG. 15, there are two frame bodies 2 mounted, which are respectively a first frame body 4 located on the right side of the cage body 1 and a third frame body 6 located on the rear side of the cage body, or a second frame body 5 located on the left side of the cage body and a third frame body 6 located on the rear side of the cage body. The first frame body 4 includes four plates: a first plate a 400, a second plate a 401, a third plate a 402, and a fourth plate a 403. The second frame body 5 includes four plates: a first plate b 500, a second plate b 501, a third plate b 502, and a fourth plate b 503. The third frame body 6 includes four plates: a first plate c 600, a second plate c 601, a third plate c 602, and a fourth plate c 603. Since the third frame body 6 interferes with the first frame body 4 or the second frame body 5 when mounted, the fourth plate a 403 of the first frame body 4 or the fourth plate b 503 of the second frame body 5 may be disassembled first, and a first end face of the third frame body 6 is engaged to end portions of the first plate a 400 and the second plate a 401 of the first frame body 4, or the first end face of the third frame body 6 is engaged to end portions of the first plate b 500 and the second plate b 501 of the second frame body 5. Then the fourth plate a 403 of the first frame body 4 or the fourth plate b 503 of the second frame body 5 is engaged to a second end face of the third frame body 6. This can not only solve the interference between the third frame body 6 and the first frame body 4 or the second frame body 5, but also make proper use of the space at a corner between the third frame body 6 and the first frame body 4 or the second frame body 5, thereby further broadening the usage space of the pet cage.

Further, for example, there are three frame bodies mounted, which are respectively a first frame body 4 located on the right side of the cage body, a second frame body 5 located on the left side of the cage body, and a third frame body 6 located on the rear side of the cage body. The first frame body 4 and the second frame body 5 are respectively mounted on the left side and the right side of the cage body first, and then the fourth plate a 403 of the first frame body 4 and the fourth plate b 503 of the second frame body 5 are disassembled, such that a first end face of the third frame body 6 is engaged to end portions of the first plate a 400 and the second plate a 401 of the first frame body 4, and the first end face of the third frame body 6 is engaged to end portions of the first plate b 500 and the second plate b 501 of the second frame body 5. Then, the fourth plate a 403 of the first frame body 4 and the fourth plate b 503 of the second frame body 5 are separately engaged to a second end face of the third frame body 6.

In the foregoing embodiment, the first plate c 600 of the third frame body 6 may be independently arranged, or may be a portion of the top panel component 100 or be of an integrally formed structure with the top panel component 100 of the cage body 1.

In some embodiments, to further expand the volume of the pet cage and the pet activity space, a plurality of frame bodies are arranged, and the plurality of frame bodies are sequentially stacked and connected in a width direction. After one of panel components is disconnected, a frame body close to the cage body is connected to the cage body, and the disconnected panel component is connected to a frame body away from the cage body. That is, the space of the pet cage is expanded by mounting, in one direction of the cage body, the plurality of frame bodies stacked in the width direction. For example, the plurality of frame bodies are arranged on the right side of the cage body, and adjacent frame bodies are engaged by fasteners, such that a larger activity space is formed inside the engaged frame bodies. The engaged frame bodies are connected to the cage body, and the disconnected right panel component is connected to a second end face of the outermost frame body. With this arrangement, the pet activity space of the pet cage can be expanded by choosing to mount the plurality of frame bodies in one direction of the cage body, such that the space of the pet cage is expanded more conveniently.

In some embodiments, at least one panel component of the cage body 1 may be configured as a functional panel, and the functional panel is configured to mount a functional accessory. That is, the functional panel is a panel component having a connection function. For example, the panel component is provided with a hole, a groove, or the like to mount a kettle, a hanger, a mounting rack, a shelf, or the like. The functional accessory includes a cup holder, the kettle, the hanger, the mounting rack, the shelf, an air purifier, a humidifier, a flowerpot, or the like.

### Embodiment 2

Still referring to FIG. 3 to FIG. 13, Embodiment 2 of the present disclosure discloses a modular pet cage, which structurally includes the cage body 1 of Embodiment 1 and at least one functional module. The cage body 1 includes a plurality of panel components, and the panel components are arranged in an enclosing manner and spliced to define a volume of the cage body 1. The functional module is connected to the cage body 1 to increase the volume of the cage body 1. The functional module has a certain volume, and is in a shape that can be fitted with the shape of the cage body 1 or the shape of any panel component of the cage body. The functional module is mounted on the cage body 1 to become a part of the cage body 1, such that the volume of the pet cage can be increased. Therefore, when the pet cage is fitted with a furniture space, the volume of the pet cage can be expanded by mounting the functional modules on the cage body 1, an appropriate number of functional modules may be selected according to a size of the furniture space to be connected to the cage body 1, and the functional modules may be connected according to a volume expansion direction of the cage body 1. Therefore, the modular pet cage has high flexibility in volume expansion, a large degree of freedom and a simple structure, and achieves ease and fastness of assembly.

Further, in this embodiment, the functional module is an independent functional component, which has various implementations. For example, the functional module may be one or more of a feeding module, a temperature control module, a disinfection module, a cleaning module, a monitoring module, a storage module 3, a decoration module, and the like. The feeding module is suitable for feeding the pets, and, for example, may use a cuboid housing. A feeding trough is arranged in the housing, and may be configured to feed pets after the feeding module is connected to the cage body. The temperature control module is a module that can control a temperature in the pet cage. For example, the temperature control module includes a housing fitted with the shape of the cage body, and the housing is connected to an outer side of the cage body. The housing is internally provided with a controller and an air conditioning system for heating or cooling. When the temperature in the pet cage is detected to be low, the pet cage can be internally heated, or when the temperature in the pet cage is detected to be high, the pet cage can be internally cooled, such that the pet cage can be internally kept at a temperature suitable for the pets to live comfortably. The disinfection module is mounted on the cage body, to disinfect the pet activity space in the cage body, for example, by ultraviolet, to prevent pet feces from deteriorating and stinking and affecting health of the pets. The cleaning module may be a cleaning device for automatically cleaning the cage body, such as a pet feces flushing system, which is provided with a water tank, a water pump, a nozzle, and the like. The monitoring module is a camera suitable for monitoring activities and rest of the pets, and is provided with a housing connected to the cage body and a camera component mounted in or on the housing. The camera component can be in communication with a mobile phone of the user, such that the user can grasp a living state of the pets in real time. The storage module 3 is a functional module suitable for storage and accommodating, for example, a cabinet, a drawer, or a shelf, such as a drawer or a storage compartment mounted on a top of the cage body 1 as shown in FIG. 5, FIG. 8, FIG. 9, and FIG. 10. The decoration module may be a flower stand, a plant planting stand, or the like that can achieve a decorative effect after planting of flowers and other plants, or is a decorative cabinet, a decorative stand, or the like that achieves the decorative effect. Any one or more of the above functional modules are mounted on the cage body 1, such that the pet cage can not only be fitted with a reserved space of existing furniture, but also form a more ecological, green and multifunctional dog cage ecosystem to meet requirements of different users. Similarly, the above functional modules are optional components, and the users may choose to mount the required functional modules according to their own requirements. When the functional module of the above embodiment, such as the storage module 3, the decoration module, or the like, is mounted on the cage body, there is no need to disassemble a panel component of the cage body. In some embodiments, when the user mounts a functional module, any panel component of the cage body may be disassembled, and then the functional module may be connected to the cage body to form an enclosure, such that the functional module and the cage body together form a complete pet cage.

In this embodiment, to make the pet cage better fitted with the reserved space of the existing furniture, the shape of the functional module may be a cuboid, a cube, an L-shaped body, another special-shaped body, or the like while the functional module is fitted with and engaged to the cage body 1. That is, the shape of the functional module is not limited in this embodiment, provided that requirements that mounting or integrated mounting is facilitated and the pet cage can be perfectly combined with the furniture are met.

Further, in this embodiment, a stacking direction of functional modules on the cage body 1 or the volume expansion direction of the cage body 1 may be the height direction, the length direction, the width direction, or the like of the cage body 1. Mounting the functional modules on at least one of the left side and the right side of the cage body 1 can increase the volume of the pet cage in the length direction of the cage body 1. Mounting the functional modules on at least one of the top and the bottom of the cage body 1 can increase the volume of the pet cage in the height direction of the cage body 1. Mounting the functional modules on at least one of the front side and the rear side of the cage body 1 can increase the volume of the pet cage in the width direction of the cage body 1. That is, the functional modules may be connected to the top, the bottom, the left side, the right side, the front side, the rear side, or the like of the cage body 1, such that the volume and the pet activity space of the cage body 1 can be expanded in the length direction, the width direction, the height direction, or any other direction. Similarly, the dimension of the functional modules is not limited in this embodiment, provided that the functional module is fitted with the reserved space of the furniture after being combined with the cage body or meets requirements of integrated assembly of the pet cage.

In some embodiments, the modular pet cage further includes at least one module component, which has an internal space, and is connected to the cage body 1 after any one of the panel components is disconnected, to increase the activity space of the cage body 1. That is, in this embodiment, based on that the functional module is mounted on the cage body 1, the module component may be further mounted on the cage body 1 to increase the pet activity space of the cage body 1. In this embodiment, the structure of the module component, the manner of mounting the module component on the cage body 1, and the like are the same as those in Embodiment 1, and details are not described in this embodiment.

It can be understood that in the above-mentioned embodiment, after the functional module and the module component are mounted on the cage body 1, a gap may occur between the functional module and the module component due to misalignment. For example, when the functional module is mounted on the top of the cage body 1 while the module component is mounted on one side of the cage body 1, and the top of the functional module is higher than that of the module component, a height difference between the top of the functional module and the top of the module component forms a gap. To make the pet cage better integrated and more perfectly fitted with the furniture space, in some embodiments, the modular pet cage further includes a splicing module. That is, the splicing module is only configured to connect and align the module component with the functional module, to achieve aesthetic appearance and decoration. The splicing module may have a plurality of dimensions to be fitted with different gap sizes, making integration between the functional module and the module component higher and the structure more compact.

In the description of embodiments of the present disclosure, it should be noted that, in the description of the present disclosure, the term such as “inner” or “outer”, which indicates a directional or positional relationship, is based on the directional or positional relationship shown in the drawings. This is merely for ease of description instead of indicating or implying that the device or member must have a specific orientation and be constructed and operated in a specific orientation, and therefore, should not be construed as limiting the present disclosure.

In the description of the present disclosure, descriptions with reference to the terms such as “an embodiment”, “some embodiments”, “in this embodiment”, “specific example”, or “some examples” mean that specific features, mechanisms, materials, or characteristics described with reference to the embodiment or example are included in at least one embodiment or example of the present disclosure. In this specification, the schematic expression of the above-mentioned terms is not necessarily directed to the same embodiment or example. Moreover, the specific features, mechanisms, materials or characteristics described may be combined in any proper manner in any one or more embodiments or examples. In addition, without any contradiction, a person skilled in the art may bind and combine different embodiments or examples and features of the different embodiments or examples that are described in this specification.

The foregoing descriptions are merely specific implementations of the present disclosure, but the protection scope of the present disclosure is not limited thereto. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1. A modular pet cage, comprising:
a cage body internally having an activity space for a pet to move in, wherein the cage body comprises a plurality of panel components, and the plurality of panel components are arranged in an enclosing manner and spliced to define a volume of the cage body; each panel component individually forms an entirety of a corresponding surface of the cage body, one side panel component is formed as a solid sheet member defining a continuous surface extending over an entire area of the side panel component; and
at least one module component having an internal space;
wherein each module component is configured to:
be connected to the cage body after any one of the panel components is disconnected, to increase the activity space of the cage body; and
extend the activity space from the cage body along an extension direction perpendicular to the disconnected panel component by an extension length;
wherein the extension length is less than a span of the cage body along the extension direction.

2. (canceled)

3. The modular pet cage of claim 2, wherein the module component is a frame body, and the frame body is configured to be connected to the cage body to form an enclosure after the panel component is disconnected, such that an internal space of the frame body communicates with an internal space of the cage body; and
wherein the frame body is formed by sequentially splicing a plurality of plates end to end, the frame body is open and has a first end face and a second end face that are located at two ends inside, and after the panel component is disconnected, the first end face of the frame body is configured to be connected to the cage body and the disconnected panel component is configured to be connected to the second end face of the frame body.

4. The modular pet cage of claim 3, wherein a cross section of the frame body is one of a polygon, a circle, or an ellipse.

5. The modular pet cage of claim 1, wherein at least one panel component is configured as a door panel capable of opening or closing the cage body.

6. The modular pet cage of claim 3, wherein the frame body comprises a first plate, a second plate, a third plate and a fourth plate, and the first plate, the second plate, the third plate and the fourth plate are sequentially detachably connected to form the frame body of a quadrilateral shape.

7. The modular pet cage of claim 6, wherein the plurality of panel components sequentially comprise a top panel component, a bottom panel component, a front panel component, a rear panel component, a left panel component and a right panel component, and the top panel component, the bottom panel component, the front panel component, the rear panel component, the left panel component and the right panel component are sequentially arranged in an enclosing manner to form the cage body of a square shape.

8. The modular pet cage of claim 7, comprising at least one of the following features:
wherein after at least one of the left panel component and the right panel component is disconnected, the frame body is configured to be connected to the cage body to increase the volume of the pet cage in a length direction;
wherein after at least one of the top panel component and the bottom panel component is disconnected, the frame body is configured to be connected to the cage body to increase the volume of the pet cage in a height direction;
wherein after at least one of the front panel component and the rear panel component is disconnected, the frame body is configured to be connected to the cage body to increase the volume of the pet cage in a width direction.

9. The modular pet cage of claim 8, comprising at least one of the following features:
wherein after the left panel component is disconnected, the first end face of the frame body is configured to be connected to a left side of the cage body, and the left panel component is configured to be connected to the second end face of the frame body;
wherein after the right panel component is disconnected, the first end face of the frame body is configured to be connected to a right side of the cage body, and the right panel component is configured to be connected to the second end face of the frame body.

10. (canceled)

11. The modular pet cage of claim 3, wherein a plurality of frame bodies are provided; and after the panel component is disconnected, the plurality of frame bodies are configured to be sequentially stacked and connected in a width direction, a frame body close to the cage body is configured to be connected to the cage body, and the disconnected panel component is connected to a frame body away from the cage body.

12. The modular pet cage of claim 1, wherein at least one panel component comprises a frame and a mesh plate connected in the frame.

13. The modular pet cage of claim 1, wherein adjacent panel components are detachably connected by an engaging element.

14. The modular pet cage of claim 1, wherein at least one panel component is configured as a functional panel, and the functional panel is configured to mount a functional accessory.

15. A modular pet cage, comprising:
a cage body internally having an activity space for a pet to move in, wherein the cage body comprises a plurality of panel components, and the plurality of panel components are arranged in an enclosing manner and spliced to define a volume of the cage body; each panel component individually forms an entirety of a corresponding surface of the cage body, one side panel component is formed as a solid sheet member defining a continuous surface extending over an entire area of the side panel component; and
at least one functional module connected to the cage body and configured to increase the volume of the cage body; and
at least one module component, which has an internal space;
wherein each module component is configured to:
be connected to the cage body after any one of the panel components is disconnected to increase the activity space of the cage body; and
extend the activity space from the cage body along an extension direction perpendicular to the disconnected panel component by an extension length;
wherein the extension length is less than a span of the cage body along the extension direction.

16. (canceled)

17. The modular pet cage of claim 15, wherein the functional module is configured to connected to the cage body to form an enclosure after any one of the panel components is disconnected.

18. The modular pet cage of claim 15, wherein the functional module is configured as one or more of a feeding module, a temperature control module, a disinfection module, a cleaning module, a monitoring module, a storage module, and a decoration module.

19. (canceled)

20. The modular pet cage of claim 19, wherein the frame body is formed by sequentially splicing a plurality of plates end to end, the frame body is open and has a first end face and a second end face that are located at two ends inside, and after the panel component is disconnected the first end face of the frame body is configured to be connected to the cage body and the disconnected panel component is configured to be connected to the second end face of the frame body.

21. The modular pet cage of claim 15, wherein the module component is a frame body, and the frame body is configured to be connected to the cage body to form an enclosure after the panel component is disconnected, such that an internal space of the frame body communicates with an internal space of the cage body.

22. The modular pet cage of claim 1, wherein a drawer matching with the cage body is dispose at a top of the cage body.

23. The modular pet cage of claim 22, wherein each module component comprises an additional structure configured to match with the drawer.
